(19) United States
(12) Patent Application Publication
(10) Pub. No.: US 2011/0286693 A1
(43) Pub. Date: Nov. 24, 2011

(54) OPTICAL WAVEGUIDE DEVICE AND RESIN COMPOSITION FOR USE IN FORMATION OF OVER CLADDING LAYER THEREOF

(75) Inventors: Chisato Gotou, Osaka (JP); Yusuke Shimizu, Osaka (JP); Mayu Takase, Osaka (JP)

(73) Assignee: NITTO DENKO CORPORATION, Osaka (JP)

(21) Appl. No.: 13/113,275

(22) Filed: May 23, 2011

(30) Foreign Application Priority Data
May 24, 2010 (JP) 2010-118514

(51) Int. Cl. G02B 6/036; C08L 63/00

(52) U.S. Cl. 385/14; 523/400

(57) ABSTRACT

An optical waveguide device capable of preventing a light-receiving element from malfunctioning when used in environments where the illuminance of disturbance light such as sunlight is high, and a resin composition for use in the formation of an over cladding layer of the optical waveguide device are provided. The optical waveguide device includes an optical waveguide, and the light-receiving element optically coupled to one end portion of the optical waveguide. The over cladding layer has a surface serving as an entrance surface which receives the disturbance light. The over cladding layer includes a hardened body of a resin composition having an ultraviolet curable resin as a main component and containing a dye that absorbs the disturbance light, and has a thickness of not less than 100 μm as measured from the top surface of cores provided in the optical waveguide to the surface of the over cladding layer.

### BACKGROUND OF THE INVENTION

1. Field of the Invention

The present invention relates to an optical waveguide device including an optical waveguide and a photoelectric conversion device which are optically coupled to each other, and a resin composition for use in the formation of an over cladding layer of the optical waveguide device.

2. Description of the Related Art

Recently, information communication using light as a medium has come into widespread use. The communication of information is performed, for example, by an optical waveguide device including an optical waveguide and a light-receiving element (a photoelectric conversion device) optically coupled to an end portion of the optical waveguide. Specifically, an optical signal propagating in cores provided in the optical waveguide is received by the light-receiving element, and is converted into an electric signal by the light-receiving element.

However, when the above-mentioned optical waveguide device is used, for example, in sunlight, sunlight is transmitted through an over cladding layer provided in the optical waveguide to enter the cores because the sunlight is high in illuminance. In general, the wavelength range of an optical signal received by the above-mentioned light-receiving element is as wide as 400 to 1000 nm, and includes the wavelength range of visible light (approximately in the range of 400 to 800 nm). For this reason, when the optical waveguide device is used in sunlight as described above, the light-receiving element receives part of the sunlight transmitted through the over cladding layer and entering the cores, causing a malfunction if no optical signal is propagated.

There has been proposed an optical waveguide device in which an organic dye liquid is applied to the surface of the over cladding layer to form an organic colored layer for blocking the transmission of disturbance light (light causing the malfunction of the light-receiving element) therethrough, thereby preventing the light-receiving element from malfunctioning, as disclosed in Japanese Published Patent Application No. 2010-39804.

However, the thickness of the organic colored layer is limited by the viscosity of the organic dye liquid used therefor and the like, and is typically not greater than 50 μm. For this reason, in environments where the illuminance of disturbance light such as sunlight is high (for example, 100,000 lux), part of the disturbance light is transmitted through the organic colored layer and also through the over cladding layer, causing the light-receiving element to malfunction in some cases. The optical waveguide device in which the organic colored layer is formed on the surface of the over cladding layer still has room for improvement in this regard.

### SUMMARY OF THE INVENTION

An optical waveguide device is provided which is capable of preventing a light-receiving element (a photoelectric conversion device) from malfunctioning when used in environments where the illuminance of disturbance light such as sunlight is high, and a resin composition for use in the formation of an over cladding layer of the optical waveguide device is also provided.

An optical waveguide device comprises: an optical waveguide including an under cladding layer, cores formed on a surface of the under cladding layer and configured to propagate an optical signal, and an over cladding layer formed on the surface of the under cladding layer so as to cover the cores, the over cladding layer having a surface serving as an entrance surface for receiving disturbance light; and a photoelectric conversion device optically coupled to the optical waveguide and configured to convert a received optical signal into an electric signal, the photoelectric conversion device having a receivable wavelength range overlapping the wavelength range of the disturbance light, the over cladding layer including a hardened body of a resin composition having an ultraviolet curable resin as a main component and containing a dye that absorbs the disturbance light, the over cladding layer having a thickness of not less than 100 μm as measured from the top surface of the cores to the surface of the over cladding layer.

A resin composition for use in formation of an over cladding layer in the above-mentioned optical waveguide device comprises: an ultraviolet curable resin as a main component; and a dye for absorbing disturbance light entering through a surface of the over cladding layer, wherein the following relation is satisfied: T500<T365<T850 where T850 is an optical signal transmittance that is a coefficient of transmission of light having a wavelength of 850 nm representative of the wavelength of an optical signal propagating in the cores, T500 is a disturbance light transmittance that is a coefficient of transmission of light having a wavelength of 500 nm representative of the wavelength of the disturbance light, and T365 is an ultraviolet light transmittance that is a coefficient of transmission of light having a wavelength of 365 nm representative of the wavelength of ultraviolet light.

The disclosed embodiments cause the over cladding layer itself, which can be made thick by die-molding and the like, to absorb the disturbance light for the purpose of preventing the photoelectric conversion device from malfunctioning when used in environments where the illuminance of the disturbance light such as sunlight is high. Studies have been made of the material for the formation of the over cladding layer, the thickness of the over cladding layer and the like. When the over cladding layer includes a hardened body of a resin composition having an ultraviolet curable resin as a main component and containing a dye that absorbs the disturbance light, and has a thickness of not less than 100 μm (as measured from the top surface of the cores), the over cladding layer itself is capable of absorbing the disturbance light, thereby preventing the photoelectric conversion device from malfunctioning.

Studies have been made of the resin composition for use in forming the over cladding layer. As a result, the resin composition having the optical signal transmittance T850, the disturbance light transmittance T500 and the ultraviolet light transmittance T365 which satisfy the following relation T500<T365<T850 is appropriate.

That is, the resin composition for the formation of the over cladding layer which satisfies the relation 1500<T365<T850 allows ultraviolet light directed onto the resin composition during the formation of the over cladding layer to be appropriately absorbed by the ultraviolet curable resin without being absorbed by the dye after entering the resin composition. Thus, the resin composition is excellent in hardenability by irradiation with the ultraviolet light, and is appropriately formed into the over cladding layer. Additionally, the over cladding layer formed in the above-mentioned manner does not become brittle although it contains the dye, and is also excellent in mechanical strength.

The relation T500<T365<T850 is satisfied also after the resin composition is hardened and formed into the over cladding layer. In other words, the disturbance light transmittance T500 of the over cladding layer is low. Combined with the thickness of the over cladding layer (not less than 100 μm as measured from the top surface of the cores), this low disturbance light transmittance T500 allows the disturbance light entering through the surface of the over cladding layer to be sufficiently absorbed by the dye in the over cladding layer. As a result, the malfunction of the photoelectric conversion device due to the disturbance light is prevented.

In a portion where the optical waveguide and the photoelectric conversion device are optically coupled to each other, an over cladding layer portion having a slight thickness is generally formed between the front end surfaces of the respective cores of the optical waveguide and the photoelectric conversion device. This is because protruding and exposed front end portions of the cores cause light to scatter from the protruding portions, thereby increasing light propagation losses. When the optical signal transmittance T850 is high as in the above-mentioned relation T500<T365<T850 with the front end surfaces of the respective cores covered with the over cladding layer portion, an optical signal emitted from the front end surfaces of the respective cores is easily transmitted through the over cladding layer portion in front of the front end surfaces of the respective cores to reach the photoelectric conversion device efficiently.

In the optical waveguide device, the over cladding layer includes a hardened body of a resin composition having an ultraviolet curable resin as a main component and containing a dye that absorbs the disturbance light, and has a thickness of not less than 100 μm as measured from the top surface of the cores to the surface of the over cladding layer. For this reason, if the disturbance light enters through the surface of the over cladding layer, the disturbance light is sufficiently absorbed by the dye in the over cladding layer. As a result, the malfunction of the photoelectric conversion device due to the disturbance light is prevented. Additionally, the optical waveguide device eliminates the need to form a new layer such as a conventional organic colored layer and the like on the surface of the over cladding layer, thereby offering an advantage in that the thickness of the optical waveguide is not increased.

Preferably, the optical signal propagating in the cores is near infrared radiation having a wavelength in the range of 700 to 1000 nm, the disturbance light is sunlight having a wavelength including the range of 400 to 700 nm, and the receivable wavelength range of the photoelectric conversion device is the range of 400 to 1000 nm. In such a case, the optical waveguide device can be used in sunlight without malfunctioning although the wavelength range of 400 to 700 nm is a range where the energy of sunlight is intense.

Preferably, the dye is selected from the group consisting of (a) a red dye and a green dye, (b) a red dye, a green dye, and a yellow dye, and (c) a red dye, a green dye, and a blue dye. In such a case, the dye is capable of absorbing different wavelength ranges depending on the color (type) thereof. Thus, the use of a plurality of colors (types) of dyes allows the setting of the wavelength range of the disturbance light which can be absorbed to a predetermined region, thereby achieving more efficient absorption of the disturbance light.

The resin composition for use in formation of the over cladding layer in the optical waveguide device includes the ultraviolet curable resin as a main component, and the dye for absorbing the disturbance light entering through the surface of the over cladding layer, whereby the optical signal transmittance T850, the disturbance light transmittance T500 and the ultraviolet light transmittance T365 satisfy the relation T500<T365<T850. When ultraviolet light is directed onto the resin composition for the formation of the over cladding layer, the ultraviolet light enters the resin composition, and is then appropriately absorbed by the ultraviolet curable resin without being absorbed by the dye. Thus, the resin composition is excellent in hardenability by irradiation with the ultraviolet light, and is appropriately formed into the over cladding layer. Additionally, the over cladding layer formed in the above-mentioned manner does not become brittle although containing the dye, and is also excellent in mechanical strength. Further, the relation T500<T365<T850 is satisfied also after the resin composition is hardened and formed into the over cladding layer. For this reason, the use of the resin composition according to the present invention provides the over cladding layer capable of reducing the amount of disturbance light transmitted therethrough. Also, the over cladding layer portion through which an optical signal emitted from the front end surfaces of the respective cores is easily transmitted is formed even when the front end surfaces of the respective cores are covered with the over cladding layer portion.

Preferably, the disturbance light transmittance is not greater than 10%, the ultraviolet light transmittance is in the range of 3 to 50%, and the optical signal transmittance is not less than 80%. In such a case, the formation of the over cladding layer is improved. Also, the over cladding layer more improved in mechanical strength is formed. Additionally, the over cladding layer capable of reducing the amount of disturbance light transmitted therethrough is formed, and the over cladding layer portion through which an optical signal emitted from the front end surfaces of the respective cores is more easily transmitted is formed.

Preferably, the proportion of the ultraviolet curable resin is in the range of 80 to 99 wt % to the total weight of the resin composition, and the proportion of the dye is in the range of 0.05 to 0.75 wt % to the total weight of the resin composition. In such a case, the formation of the over cladding layer is further improved. Also, the over cladding layer further improved in mechanical strength is formed. Additionally, the over cladding layer capable of further reducing the amount of disturbance light transmitted therethrough is formed, and the over cladding layer portion through which an optical signal emitted from the front end surfaces of the respective cores is much more easily transmitted is formed.

Preferably, the dye is selected from the group consisting of (a) a red dye and a green dye, (b) a red dye, a green dye, and a yellow dye, and (c) a red dye, a green dye, and a blue dye. In such a case, the dye is capable of absorbing different wavelength ranges depending on the type (color) thereof. Thus, the use of a plurality of types (colors) of dyes allows the setting of the wavelength range of the disturbance light which can be absorbed to a predetermined region, thereby providing the over cladding layer capable of absorbing the disturbance light more efficiently.

### BRIEF DESCRIPTION OF THE DRAWINGS

FIG. 1A is a longitudinal sectional view schematically showing an optical waveguide device according to a preferred embodiment.

FIG. 1B is a transverse sectional view schematically showing the optical waveguide device according to the preferred embodiment.

FIGS. 2A to 2D are views schematically illustrating a method of manufacturing an optical waveguide in the optical waveguide device according to the preferred embodiment.

FIG. 3 is a graph showing the absorption spectrum of an over cladding layer in inventive examples and a comparative example.

### DETAILED DESCRIPTION OF THE INVENTION

A preferred embodiment will now be described in detail with reference to the drawings.

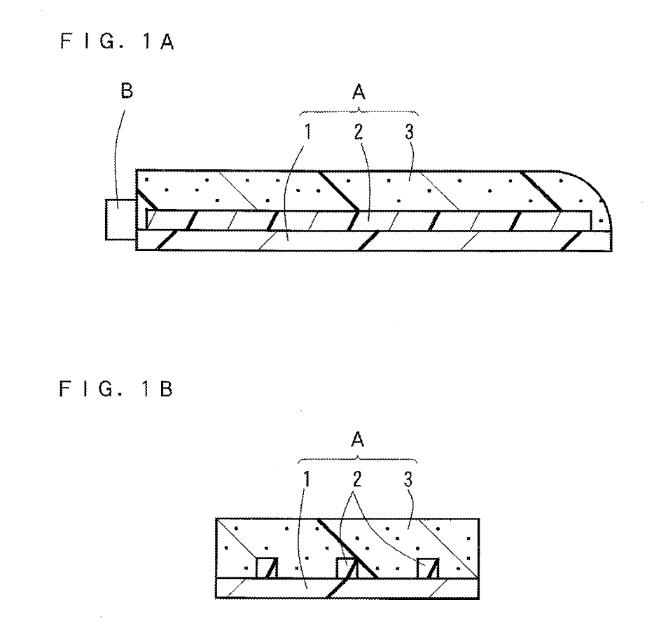

FIG. 1A is a longitudinal sectional view schematically showing an optical waveguide device according to the preferred embodiment, and FIG. 1B is a transverse sectional view thereof. This optical waveguide device includes an optical waveguide A, and a light-receiving element (a photoelectric conversion device) B optically coupled to one end portion (a left-hand end portion as seen in FIG. 1A) of the optical waveguide A. This optical waveguide device is used in environments where the illuminance of disturbance light such as sunlight is high. The optical waveguide A includes an over cladding layer 3 having a surface serving as an entrance surface (a light receiving surface) which receives the disturbance light. For the purpose of absorbing the disturbance light in the over cladding layer 3 to prevent the light-receiving element B from malfunctioning, the over cladding layer 3 includes a hardened body of a resin composition having an ultraviolet curable resin as a main component and containing a dye or coloring matter that absorbs the disturbance light, and has a thickness of not less than 100 μm as measured from the top surface of cores 2 provided in the optical waveguide A to the surface of the over cladding layer 3.

As shown in FIGS. 1A and 1B, the optical waveguide A includes an under cladding layer 1, the cores 2 formed on a surface of the under cladding layer 1 and for propagating an optical signal, and the over cladding layer 3 formed on the surface of the under cladding layer 1 so as to cover the cores 2. In this preferred embodiment, front end surfaces of the respective cores 2 are covered with a portion of the over cladding layer 3, and the front end surfaces of the respective cores 2 and the light-receiving element B are optically coupled to each other through the portion of the over cladding layer 3.

In general, near infrared radiation having a wavelength in the range of 700 to 1000 nm is used as the optical signal propagating in the cores 2. In particular, near infrared radiation having a wavelength of 850 nm is preferably used.

The light-receiving element B receives the optical signal propagated in the cores 2 to convert the optical signal into an electric signal. A light-receiving element capable of receiving an optical signal having a wavelength in the range of 400 to 1000 nm is typically used as the light-receiving element B. Preferred examples of such a light-receiving element B include a CMOS (complementary metal-oxide-semiconductor) image sensor and a CCD (charge-coupled device) image sensor.

The disturbance light entering through the surface of the over cladding layer 3 is, in general, sunlight. Sunlight is light having a wide wavelength range including infrared, visible and ultraviolet radiation. In particular, sunlight has an intense-energy region corresponding to a wavelength range of 400 to 700 nm. For this reason, when the disturbance light is sunlight, the dye used herein is a dye that absorbs light having a wavelength in the range of 400 to 780 nm including the intense-energy wavelength range of sunlight.

Next, a method of manufacturing the optical waveguide A will be described in detail.

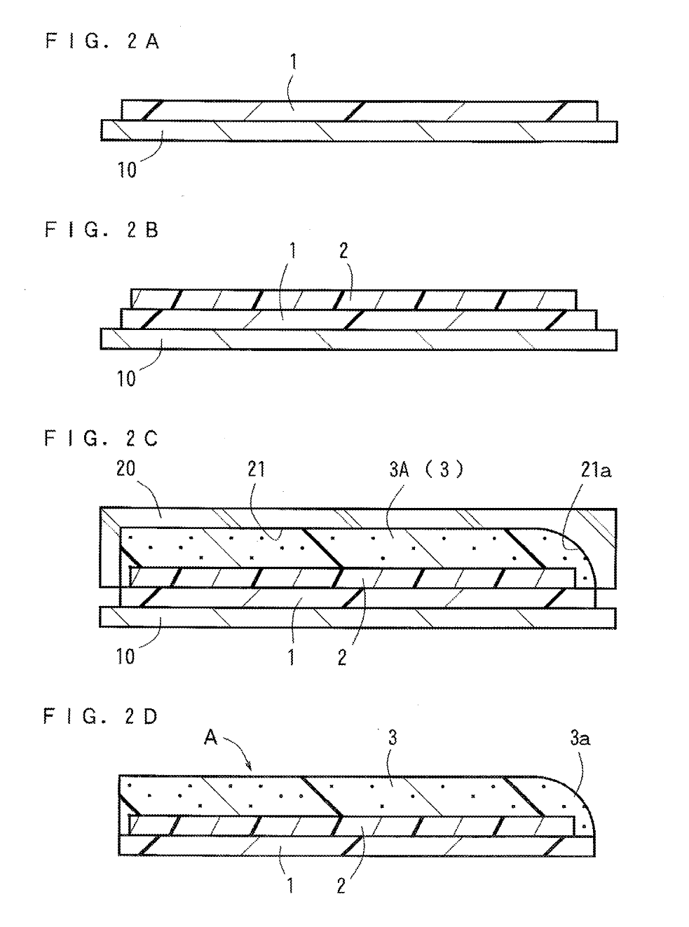

First, a base 10 of a flat shape (with reference to FIG. 2A) for use in the formation of the under cladding layer 1 is prepared. Examples of a material for the formation of the base 10 include resin, glass, quartz, silicon, metal and the like. The thickness of the base 10 is, for example, in the range of 20 μm (in film form) to 5 mm (in plate form).

Then, as shown in FIG. 2A, the under cladding layer 1 is formed on a predetermined region of a surface of the base 10. Examples of a material for the formation of the under cladding layer 1 include thermosetting resins and photosensitive resins. When a thermosetting resin is used, a varnish prepared by dissolving the thermosetting resin in a solvent is applied to the base 10 and is then heated to thereby form the under cladding layer 1. When a photosensitive resin is used, on the other hand, a varnish prepared by dissolving the photosensitive resin in a solvent is applied to the base 10 and is then exposed to irradiation light such as ultraviolet light to thereby form the under cladding layer 1. The thickness of the under cladding layer 1 is preferably in the range of 5 to 50 μm.

Next, as shown in FIG. 2B, the cores 2 having a predetermined pattern are formed on a surface of the under cladding layer 1. Examples of a method of forming the cores 2 include a dry etching method using plasma, a transfer method, an exposure and development method, and a photo-bleaching method. Preferably, a photosensitive resin excellent in patterning characteristics is used as a material for the formation of the cores 2. Examples of the photosensitive resin include acrylic based ultraviolet curable resins, epoxy based ultraviolet curable resins, siloxane based ultraviolet curable resins, norbornene based ultraviolet curable resins, and polyimide based ultraviolet curable resins. These resins are used either singly or in combination. Examples of the sectional configuration of the cores 2 include a trapezoid and a rectangle having excellent patterning characteristics. The width of the cores 2 is preferably in the range of 10 to 500 μm. The thickness (height) of the cores 2 is preferably in the range of 10 to 100 μm.

The material for the formation of the cores 2 used herein has a refractive index greater than that of the material for the formation of the under cladding layer 1 described above and the over cladding layer 3 to be described below (with reference to FIG. 2D), and is highly transparent to the wavelength of the optical signal to be propagated. The refractive index is adjusted, i.e. increased or decreased as appropriate, by changing at least one of the type and content of an organic group introduced into the resins that are the materials for the formation of the under cladding layer 1, the cores 2 and the over cladding layer 3. As an example, the refractive index is increased by introducing a cyclic aromatic group (e.g., a phenyl group) into resin molecules or by increasing the content of the aromatic group in the resin molecules. On the other hand, the refractive index is decreased by introducing a straight-chain or cyclic aliphatic group (e.g., a methyl group and a norbornene group) into the resin molecules or by increasing the content of the aliphatic group in the resin molecules.

Next, a material for the formation of the over cladding layer 3 (with reference to FIG. 2D) is prepared. This material is a resin composition 3A (with reference to FIG. 2C) having an ultraviolet curable resin as a main component and containing a dye or coloring matter that absorbs the disturbance light. This resin composition 3A has an optical signal transmittance T850, a disturbance light transmittance T500 and an ultraviolet light transmittance T365 which satisfy the following relation: T500<T365<T850. The optical signal transmittance T850 is a coefficient of transmission of light having a wavelength of 850 nm representative of the wavelength of the optical signal (near infrared radiation having a wavelength in the range of 700 to 1000 nm) propagating in the cores 2. The disturbance light transmittance T500 is a coefficient of transmission of light having a wavelength of 500 nm representative of the wavelength of the disturbance light (sunlight having a wavelength in the range of 400 to 700 nm). The ultraviolet light transmittance T365 is a coefficient of transmission of light having a wavelength of 365 nm representative of the wavelength of the ultraviolet light. The resin composition 3A which is the material for the formation of the over cladding layer 3 is a characteristic of the present invention.

In the range where the above-mentioned relation is satisfied, it is preferable that the disturbance light transmittance T500 is not greater than 10%, the ultraviolet light transmittance T365 is in the range of 3 to 50%, and the optical signal transmittance T850 is not less than 80%.

Examples of the ultraviolet curable resin in the resin composition 3A include ultraviolet curable resins (acrylic based ultraviolet curable resins and the like) similar to those used as the material for the formation of the cores 2. The proportion of the ultraviolet curable resin in the resin composition 3A is preferably in the range of 80 to 99 wt % to the total weight of the resin composition 3A.

When the disturbance light is sunlight, the dye used herein is a dye that absorbs light having a wavelength in the range of 400 to 780 nm, as mentioned earlier. Also, the dye is capable of absorbing different wavelength ranges depending on the type (color) thereof. For this reason, preferably two types of dyes are used. More preferably, three types of dyes are used. For the two types of dyes, a combination of red and green dyes is preferably used. For the three types of dyes, a combination of red, green and yellow dyes or a combination of red, green and blue dyes is preferably used. The use of a plurality of types (colors) of dyes as mentioned above allows the setting of the wavelength range of the disturbance light absorbable by the over cladding layer 3 to a predetermined region, thereby achieving the formation of the over cladding layer 3 which is capable of absorbing the disturbance light more efficiently. The proportion of the dyes in the resin composition 3A is preferably in the range of 0.05 to 0.75 wt % to the total weight of the resin composition 3A.

In addition to the ultraviolet curable resin and the dyes, materials contained in the resin composition 3A are additives including a photo-acid generator and the like.

Next, a molding die 20 for the formation of the over cladding layer 3 is prepared, as shown in FIG. 2C. A recessed portion 21 having a die surface complementary in shape to the over cladding layer 3 (with reference to FIG. 2D) is formed in the lower surface of the molding die 20. In this preferred embodiment, one end portion (a right-hand end portion as seen in FIG. 2C) of the recessed portion 21 is configured in the form of a lens-shaped curved surface 21a. The molding die 20 further includes an inlet (not shown) for the injection of the material for the formation of the over cladding layer 3 therethrough into the molding die 20, the inlet being in communication with the recessed portion 21. Also, it is necessary that the resin composition 3A be exposed to ultraviolet light directed through the molding die 20. For this reason, a molding die made of a material permeable to ultraviolet light (for example, a molding die made of quartz) is used as the molding die 20.

Then, the lower surface of the molding die 20 is brought into intimate contact with the surface of the under cladding layer 1 so that the cores 2 are placed in the recessed portion 21 of the molding die 20. Then, the resin composition 3A which is the material for the formation of the over cladding layer 3 is injected through the inlet formed in the molding die 20 into a mold space surrounded by the die surfaces of the recessed portion 21, the surface of the under cladding layer 1 and the surfaces of the cores 2 so that the mold space is filled with the resin composition 3A. Next, the resin composition 3A is exposed to ultraviolet light directed through the molding die 20. Thereafter, a heating treatment is performed, as required. This hardens the resin composition 3A to form the over cladding layer 3 having one end portion configured in the form of a lens portion 3a. The thickness of the over cladding layer 3 as measured from the top surfaces of the cores 2 is not less than 100 μm, preferably not less than 500 μm, more preferably in the range of 800 to 1500 μm.

In the step of forming the over cladding layer 3, the resin composition 3A satisfies the relation T500<T365<T850, whereby the ultraviolet light directed onto the resin composition 3A enters the resin composition 3A, and thereafter is appropriately absorbed by the ultraviolet curable resin without being absorbed by the dyes. Thus, the resin composition 3A is excellent in hardenability by irradiation with ultraviolet light, and is appropriately formed into the over cladding layer 3. Additionally, the over cladding layer 3 formed in the above-mentioned manner does not become brittle despite containing the dyes, and is also excellent in mechanical strength.

Next, the molding die 20 is removed, as shown in FIG. 2D. Thereafter, the base 10 (with reference to FIG. 2C) is stripped from the under cladding layer 1. Thus, the optical waveguide A including the under cladding layer 1, the cores 2, and the over cladding layer 3 is provided.

Then, the light-receiving element B is optically coupled to the one end portion (the left-hand end portion as seen in FIG. 2D) of the optical waveguide A. This provides the optical waveguide device shown in FIGS. 1A and 1B.

The above-mentioned optical waveguide device may be used as a detection means for detecting a finger touch position and the like on a touch panel. This is done, for example, by configuring the optical waveguide in the form of an L-shaped plate. Specifically, the cores 2 are formed in the optical waveguide configured in the form of the L-shaped plate so as to extend in parallel with the inner edge portion of the L-shaped plate from the corner of the L-shaped plate and to be disposed at equally spaced intervals. A light-receiving element is optically coupled to the outside of the corner of the optical waveguide. Thus, the optical waveguide device is produced. The provision of the optical waveguide device along the periphery of a display screen of a rectangular display of the touch panel allows the use of the optical waveguide device as the detection means for detecting the finger touch position and the like on the touch panel even in environments where the illuminance of disturbance light such as sunlight is high.

Although the dyes are contained only in the over cladding layer 3 in the above-mentioned preferred embodiment, the dyes may be contained similarly in the under cladding layer 1.

Next, inventive examples will be described in conjunction with a comparative example. It should be noted that the present invention is not limited to the inventive examples.

### EXAMPLES

### Material for Formation of Under Cladding Layer

A material for the formation of an under cladding layer was prepared by mixing 100 parts by weight of an epoxy based ultraviolet curable resin having an alicyclic skeleton (EP4080E available from ADEKA Corporation), and two parts by weight of a photo-acid generator (CPI-200X available from San-Apro Ltd.) together.

### Material for Formation of Cores

A material for the formation of cores was prepared by mixing 40 parts by weight of an epoxy based ultraviolet curable resin having a fluorene skeleton (OGSOL EG available from Osaka Gas Chemicals Co., Ltd.), 30 parts by weight of an epoxy based ultraviolet curable resin having a fluorene skeleton (EX-1040 available from Nagase ChemteX Corporation), 30 parts by weight of 1,3,3-tris{4-[2-(3-oxetanyl)]butoxyphenyl}butane, one part by weight of the photo-acid generator (CPI-200X available from San-Apro Ltd.), and 41 parts by weight of ethyl lactate together.

### Material for Formation of Over Cladding Layer: Resin Composition X

A material for the formation of an over cladding layer was prepared by mixing 100 parts by weight of the epoxy based ultraviolet curable resin having an alicyclic skeleton (EP4080E available from ADEKA Corporation), two parts by weight of the photo-acid generator (CPI-200X available from San-Apro Ltd.), 0.05 part by weight of a red dye (Plast Red 8335 available from Arimoto Chemical Co., Ltd.), 0.05 part by weight of a green dye (Plast Green 8620 available from Arimoto Chemical Co., Ltd.), and 0.05 part by weight of a yellow dye (Plast Yellow 8070 available from Arimoto Chemical Co., Ltd.) together.

The resin composition X was placed in a tubular cell (having a wall thickness of 1 mm) made of quartz and having a bottom. The tubular cell was set in a spectrophotometer (V-670 available from JASCO Corporation), and measurements were made on the resin composition X with the spectrophotometer. As a result of the measurements, the resin composition X showed a disturbance light transmittance T500 of 3.6%, an ultraviolet light transmittance T365 of 18.6%, and an optical signal transmittance T850 of 99.5% to satisfy the relation T500<T365<T850.

### Material for Formation of Over Cladding Layer: Resin Composition Y

A material for the formation of the over cladding layer was prepared by mixing 100 parts by weight of the epoxy based ultraviolet curable resin having an alicyclic skeleton (EP4080E available from ADEKA Corporation), two parts by weight of the photo-acid generator (CPI-200X available from San-Apro Ltd.), 0.03 part by weight of a red dye (Oil Scarlet 5206 available from Arimoto Chemical Co., Ltd.), 0.03 part by weight of the green dye (Plast Green 8620 available from Arimoto Chemical Co., Ltd.), and 0.03 part by weight of a blue dye (Plast Blue 8590 available from Arimoto Chemical Co., Ltd.) together.

Measurements were made on the resin composition Y with the above-mentioned spectrophotometer. As a result of the measurements, the resin composition Y showed a disturbance light transmittance T500 of 0.8%, an ultraviolet light transmittance T365 of 17.1%, and an optical signal transmittance T850 of 100% to satisfy the relation T500<T365<T850.

### Material for Formation of Over Cladding Layer: Resin Composition Z

A material for the formation of the over cladding layer was prepared by mixing 100 parts by weight of the epoxy based ultraviolet curable resin having an alicyclic skeleton (EP4080E available from ADEKA Corporation), and two parts by weight of the photo-acid generator (CPI-200X available from San-Apro Ltd.) together.

Measurements were made on the resin composition Z with the above-mentioned spectrophotometer. As a result of the measurements, the resin composition Z showed a disturbance light transmittance T500 of 99.9%, an ultraviolet light transmittance T365 of 75.7%, and an optical signal transmittance T850 of 99.9%.

### Inventive Example 1

### Production of Optical Waveguide

First, the material for the formation of the under cladding layer was applied to a surface of a polyethylene naphthalate film (base) having a thickness of 188 μm with an applicator. Subsequently, the applied material was exposed to ultraviolet light irradiation at a dose of 1000 mJ/cm². Thereafter, a heating treatment was performed at 80° C. for five minutes. Thus, the under cladding layer (having a thickness of 20 μm) was formed.

Then, the material for the formation of the cores was applied to a surface of the under cladding layer with an applicator. Thereafter, a heating treatment was performed at 100° C. for five minutes. Thus, a photosensitive resin layer for the formation of the cores was formed. Next, the photosensitive resin layer was exposed to ultraviolet light irradiation through a photomask having an opening pattern identical in shape with the pattern of the cores. Thereafter, a heating treatment was performed. Next, development was performed using a developing solution to dissolve away unexposed portions of the photosensitive resin layer. Thereafter, a heating treatment was performed. Thus, the cores of a rectangular sectional configuration having a width of 20 μm and a height of 50 μm were formed.

Next, a molding die made of quartz for the die-molding of the over cladding layer was set so as to cover the cores. Then, the resin composition X serving as the material for the formation of the over cladding layer was injected into a mold space defined in the molding die. Thereafter, the resin composition X was exposed to ultraviolet light irradiation at a dose of 1000 mJ/cm² through the molding die. Then, the molding die was removed. This provided the over cladding layer (having a thickness of 950 μm as measured from the top surface of the cores). In this manner, an optical waveguide was produced.

### Production of Optical Waveguide Device

A light-receiving element (a CMOS linear sensor array available from Optowell Co., Ltd.) was prepared. The light-receiving element was positioned so that an optical signal propagating in the cores was received by a light-receiving section of the light-receiving element. In this state, the light-receiving element was fixed to the above-mentioned optical waveguide with an adhesive, and the light-receiving element and the optical waveguide were optically coupled to each other. In this manner, an optical waveguide device was produced.

### Inventive Example 2

The resin composition Y was used as the material for the formation of the over cladding layer in Inventive Example 1, and was exposed to ultraviolet light irradiation at a dose of 3000 mJ/cm². Except for these differences, an optical waveguide device in Inventive Example 2 was produced in a manner similar to that in Inventive Example 1.

### Comparative Example

The resin composition Z was used as the material for the formation of the over cladding layer in Inventive Example 1. Except for this difference, an optical waveguide device in Comparative Example was produced in a manner similar to that in Inventive Example 1.

### Light Transmittance (Absorption Spectrum) of Over Cladding Layer

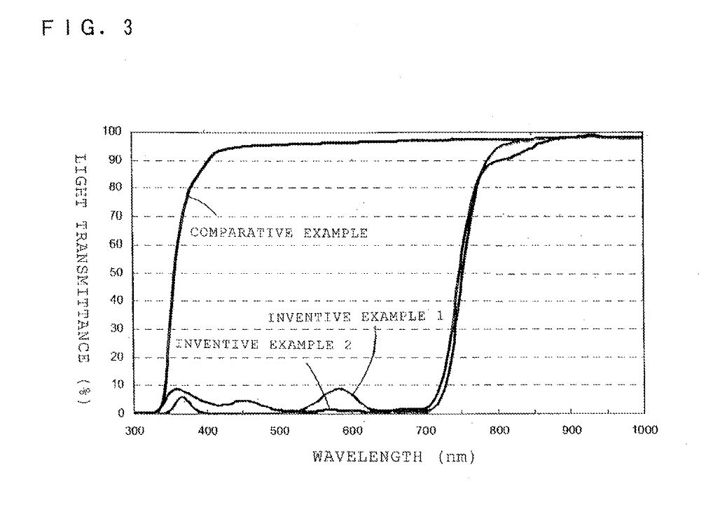

A small piece was cut from the over cladding layer in the optical waveguide in each of Inventive Examples 1 and 2 and the Comparative Example, and was placed into liquid paraffin that previously filled a tubular cell (having a wall thickness of 1 mm) made of quartz and having a bottom. The tubular cell was set in the spectrophotometer (V-670 available from JASCO Corporation), and measurements were made on the small piece with the spectrophotometer. As a result of the measurements, the light transmittance (absorption spectrum) of the over cladding layer in the optical waveguide in each of Inventive Examples 1 and 2 and the Comparative Example was obtained as shown in FIG. 3. The small piece cut from the over cladding layer had a roughened surface. The liquid paraffin was used to prevent surface scattering of light due to the roughened surface.

### Evaluations: Received Light Intensity of Light-Receiving Element

The surface of the over cladding layer in the optical waveguide device in each of Inventive Examples 1 and 2 and the Comparative Example was irradiated with light having an illuminance of 100,000 lux (corresponding to direct sunlight). As a result of measurements, the intensity of light received by the light-receiving element was 0.3 V in Inventive Examples 1 and 2, and 3.0 V in the Comparative Example.

The intensity of light received by the light-receiving element is ideally 0 V. However, it has been found that no malfunction occurs practically when the intensity of light received by the light-receiving element is not greater than 2 V. Thus, the above-mentioned results show that the optical waveguide devices in Inventive Examples 1 and 2 can be used in direct sunlight without malfunctioning, whereas the optical waveguide device in the Comparative Example malfunctions in direct sunlight and cannot be used appropriately.

Although specific forms of embodiments of the instant invention have been described above and illustrated in the accompanying drawings in order to be more clearly understood, the above description is made by way of example and not as a limitation to the scope of the instant invention. It is contemplated that various modifications apparent to one of ordinary skill in the art could be made without departing from the scope of the invention.

The optical waveguide device may be used for detection means for detecting a finger touch position and the like on a touch panel, or information communications devices and signal processors for transmitting and processing digital signals representing sound, images and the like at high speeds in environments where the illuminance of disturbance light such as sunlight is high.

What is claimed is:

1. An optical waveguide device, comprising:
an optical waveguide including an under cladding layer, cores formed on a surface of the under cladding layer and configured to propagate an optical signal, and an over cladding layer formed on the surface of the under cladding layer so as to cover the cores, the over cladding layer having a surface serving as an entrance surface for receiving disturbance light; and
a photoelectric conversion device optically coupled to the optical waveguide and configured to convert a received optical signal into an electric signal, the photoelectric conversion device having a receivable wavelength range overlapping the wavelength range of the disturbance light,
wherein the over cladding layer includes a hardened body of a resin composition having an ultraviolet curable resin as a main component and containing a dye that absorbs the disturbance light, and
wherein the over cladding layer has a thickness of not less than 100 μm as measured from the top surface of the cores to the surface of the over cladding layer.

2. The optical waveguide device according to claim 1, wherein the optical signal propagating in the cores is near infrared radiation having a wavelength in the range of 700 to 1000 nm, the disturbance light is sunlight having a wavelength including the range of 400 to 700 nm, and the receivable wavelength range of the photoelectric conversion device is the range of 400 to 1000 nm.

3. The optical waveguide device according to claim 1, wherein the dye is selected from the group consisting of:
(a) a red dye and a green dye,
(b) a red dye, a green dye, and a yellow dye, and
(c) a red dye, a green dye, and a blue dye.

4. The optical waveguide device according to claim 2, wherein the dye is selected from the group consisting of:
(a) a red dye and a green dye,
(b) a red dye, a green dye, and a yellow dye, and
(c) a red dye, a green dye, and a blue dye.

5. A resin composition for use in formation of an over cladding layer in an optical waveguide device comprising an optical waveguide including cores and an over cladding layer, the resin composition comprising:
an ultraviolet curable resin as a main component; and
a dye for absorbing disturbance light entering through a surface of the over cladding layer,
wherein the following relation is satisfied:
T500<T365<T850
where T850 is an optical signal transmittance that is a coefficient of transmission of light having a wavelength of 850 nm representative of the wavelength of an optical signal propagating in the cores, T500 is a disturbance light transmittance that is a coefficient of transmission of light having a wavelength of 500 nm representative of the wavelength of the disturbance light, and T365 is an ultraviolet light transmittance that is a coefficient of transmission of light having a wavelength of 365 nm representative of the wavelength of ultraviolet light.

6. The resin composition according to claim 5, wherein the disturbance light transmittance is not greater than 10%, the ultraviolet light transmittance is in the range of 3 to 50%, and the optical signal transmittance is not less than 80%.

7. The resin composition according to claim 5, wherein the proportion of the ultraviolet curable resin is in the range of 80 to 99 wt % to the total weight of the resin composition, and the proportion of the dye is in the range of 0.05 to 0.75 wt % to the total weight of the resin composition.

8. The resin composition according to claim 6, wherein the proportion of the ultraviolet curable resin is in the range of 80 to 99 wt % to the total weight of the resin composition, and the proportion of the dye is in the range of 0.05 to 0.75 wt % to the total weight of the resin composition.

9. The resin composition according to claim 5, wherein the dye is selected from the group consisting of:
(a) a red dye and a green dye,
(b) a red dye, a green dye, and a yellow dye, and
(c) a red dye, a green dye, and a blue dye.

10. The resin composition according to claim 6, wherein the dye is selected from the group consisting of:
(a) a red dye and a green dye,
(b) a red dye, a green dye, and a yellow dye, and
(c) a red dye, a green dye, and a blue dye.

11. The resin composition according to claim 7, wherein the dye is selected from the group consisting of:
(a) a red dye and a green dye,
(b) a red dye, a green dye, and a yellow dye, and
(c) a red dye, a green dye, and a blue dye.

12. The resin composition according to claim 8, wherein the dye is selected from the group consisting of:
(a) a red dye and a green dye,
(b) a red dye, a green dye, and a yellow dye, and
(c) a red dye, a green dye, and a blue dye.
